(19) United States
(12) Patent Application Publication
(10) Pub. No.: US 2026/0316256 A1
(43) Pub. Date: Oct. 15, 2026

(54) A MARKING MODULE FOR MARKING A WORK SURFACE

(71) Applicant: METAL MANUFACTURES PTY LIMITED, Port Kembla NSW (AU)

(72) Inventors: Alex MATTHEWS, Port Kembla NSW (AU); Izaac Piper, Port Kembla NSW (AU)

(21) Appl. No.: 19/475,118

(22) PCT Filed: Apr. 12, 2024
(86) PCT No.: PCT/AU2024/050352

§ 371 Date: Oct. 14, 2025

(30) Foreign Application Priority Data
Apr. 14, 2023 (AU) 2023901099

(51) Int. Cl. B25H 7/04; B25B 27/10; B25H 7/00

(52) U.S. Cl. CPC B25H 7/04; B25B 27/10; B25H 7/005

(57) ABSTRACT

A marking module for marking a work surface including:
a mount for mounting on a tool;
a frame for operatively mounting to a tool, the frame including a bracket movably mounted to the mount, wherein in use the frame is movably mounted to the mount via the bracket;
a receiver configured to receive a marker, and
an actuator operatively connected to the marker, the actuator for depositing a predefined quantity of a material on a work surface to form a mark.

### TECHNICAL FIELD

The present disclosure broadly relates to a marking module for marking a work surface and, more particularly, to a tool including a marking module for marking a work surface.

### BACKGROUND

To connect pipes, it is known to use sleeve-shaped press fittings which are made of plastic or metal. In order to produce the pipe connection, the pipe ends and the press fitting are inserted into one another and pressed together radially. The press fitting and the pipes are pressed with the aid of a press device. Press devices have two or more pressing jaws which can be moved radially inwards during the pressing process to form a closed pressing space.

The pipe connections are produced in particular for the installation of water-carrying, as well as gas-carrying pipes in buildings. A large number of pressing have to be carried out, even in places where the pressing cannot be adequately controlled visually because it is difficult to access and/or little light is available. In order to check the tightness of the pipe connection, the lines can be filled with a liquid or subjected to a pressure test. However, if there is a leak, this results in the medium used escaping, which can result in damage to the building.

Marking devices with a marking pen are known, the marking indicating whether pressing has been applied to the joint. However, these devices rely on a user marking the surface after the pressing has been carried out.

Also known are paints which are coated on a surface of the pipes and change colour under pressure by a pressing device indicating sufficient force has been applied to the pipe to connect the pipes together. Further, it is known to apply a tape or other adherent material on an outer surface of a pipe so that when pressure is applied by the pressing device, the tape separates into two or more segments indicating that sufficient force has been applied to the pipe to connect the pipes together. However, applying these tapes or paints to the press area of the pipe can be a time consuming process.

Processes for improving pipe fitting connection testing are desirable.

Accordingly, the present invention is predicated on attempting to improve marking devices which are used in pipe fitting connection testing.

### SUMMARY

The present invention is directed towards a marking module and a tool including a marking module, which may ameliorate at least one of the abovementioned disadvantages, or provide the consumer with a useful, or commercial choice.

In a first aspect, there is provided a marking module for marking a work surface including:
a mount for mounting on a tool;
a frame operatively connected to the mount;
a marker receiver mounted on the frame, the receiver configured to receive a marker, and
an actuator operatively connected to the marker receiver, the actuator operatively connected to the marker for depositing a predefined quantity of a material on a work surface to create a mark thereon.

The marking module may include a mount for mounting on a tool. The mount may be removably mounted to the tool, may be permanently mounted to the tool or may be integrated into the tool such that the mount and a portion of the tool form a single item. The mount may be removably mounted to the tool.

The mount may be mounted on a tool by any suitable means. For instance, the mount and the tool may comprise complementary male female connectors, the mount may be magnetically mounted to the tool, or the mount may be adhered to the tool.

The marking module may include a frame for operatively mounting to a tool. In this instance, it will be understood that when operatively mounted to the tool, the frame is mounted to the tool in such a manner that the marker, received in the receiver, can be actuated by the actuator to mark a work surface.

The frame may include a bracket movably mounted to the mount, wherein in use, the frame is movably mounted to the mount via the bracket.

The bracket may be pivotally, hingedly, and/or slidably mounted to the mount. In embodiments, the bracket may be slidably mounted to the mount.

The bracket may be fixedly connected to the frame, wherein the bracket provides the frame with at least one degree of freedom of movement relative to the tool. In other embodiments, the bracket may be movably connected to the frame, wherein the bracket provides the frame with at least two degrees of freedom of movement relative to the tool.

In use, when mounted to the tool, the frame may move relative to the tool, such that the distance and/or angle between the frame and the work surface to be marked may be varied.

The frame may be provided with a release mechanism, such as a button, operatively connected to the bracket, which when pressed allows the bracket to slide at least partially along the length of the mount. The release mechanism may act to lock and unlock the bracket to the mount controlling movement of the bracket relative the mount.

In an embodiment, the frame may be removably mounted to the tool. The bracket and/or the mount may be configured to enable the removal of the frame from the tool. The frame may be removed from the tool by sliding the bracket along the length of the mount and off of an end of the mount. The frame may be removed from the tool by pressing a release mechanism which when pressed may cause the bracket to change conformation such that the bracket may be disengaged from the mount.

The frame may comprise a housing having a first end and an opposed second end and at least one side wall extending therebetween. The at least one side wall forming a cavity therein, the cavity configured for receiving a marker and an actuator operatively connected to the marker therein.

The housing may have any suitable shape in cross-section. For instance, the housing may be have a substantially oval, stadium, rectangular or square shape in cross-section.

The housing may be of any suitable dimensions. Generally, however, the size, shape and configuration of the housing may vary depending on the type of tool to which is mounted and the type and number of markers to be received within the housing.

In an embodiment, the frame may be provided with an opening at a first end thereof, the marker in communication with the opening for emitting the material therethrough.

The marking module may include a receiver configured to receive a marker, the receiver disposed within the cavity. The receiver may be configured to receive and hold the marker in communication with the opening at the first end of the frame.

The marking module may include at least one receiver, wherein each receiver is configured to receive a marker. In this instance, the frame may be provided with an opening for each marker.

The frame may be provided with an opening such that a user can access the marker in the cavity via the opening. The opening may be provided with a door, wherein the door closes the opening. The door may be slidably or hingedly connected to the frame. The door may be provided with a release mechanism operatively connected to the door, which when operated by a user causes a door located in the frame to open. In other embodiments, the door may be provided with an engagement portion which allows the user to manually slide the door off of the opening.

The marking module may include an actuator operatively connected to a marker, the actuator for depositing a predefined quantity of a material on a work surface to form a mark. In use, actuation of the marker may cause a valve in the nozzle to open emitting the material.

The actuator may be operated manually by a user, operated remotely by a user, and/or operated autonomously or semi-autonomously in response to an operation of the tool. As used herein, the term “autonomous” refers to the ability of the marking module to be actuated with minimal human intervention.

The marking module may comprise a button located on the frame and operable by a user, wherein pressing of the button actuates the actuator. The button may comprise a touch sensor coupled to the actuator.

The marking module may comprise a controller operatively connected to the actuator and configured to actuate the actuator.

The controller may include a communications interface configured to receive and transmit a signal and a processing unit coupled to the actuator and the communications interface, the processing unit configured to actuate the actuator.

The actuator may be in wired or wireless communication with the controller. The actuator may be actuated via a wireless signal, such as by WiFi, Bluetooth, NFC, TCIP/IP, etc.

In an embodiment, the actuator may be actuated in response to an operation of the tool. For example, the closing of the jaws of a tool may cause the actuation of the marker. In other embodiments, the actuator may be actuated in response to a sensor reading from the tool. For example, the jaw pressure attaining a pre-set pressure value may cause the actuation of the marker.

Actuation of the marker may cause the marker to move position in the frame from an unarmed position to an armed position, wherein in the armed position the nozzle is brought into contact with a surface of the first end of the frame causing a valve in the nozzle to open and emit the material.

Actuation of the marker may comprise applying a force to an end of the marker which causes the marker to move position in the frame. Alternatively, actuation of the marker may cause the receiver to move position within the frame, wherein movement of the receiver causes the marker to move position in the frame from an unarmed position to an armed position.

In other embodiments, the actuator comprises an actuation arm connected to or associated with the nozzle, such that movement of the actuation arm engages the nozzle causing the nozzle to move downwardly with respect to the canister and emitting the material.

In still other embodiments, the valve in the nozzle may be electrically actuated, causing the valve to open and emit the material.

In an embodiment, the marking module may comprise a marker, the marker including a marking device configured to be actuated by an actuator and wherein upon actuation, the marking device deposits a predefined quantity of a material on a work surface to form a mark.

The frame may be provided with a release mechanism, which when pressed, causes a door located in the frame to open such that a user can access the marker. The door may be slidably or hingedly connected to the frame.

In an embodiment, the frame may be provided with a lighting device at a first end thereof, the lighting device configured to illuminate a surface to be marked. In this instance, the user may use the lighting device to confirm that the material has been deposited on the surface to be marked.

The lighting device may be an LED light. The lighting device may be operatively connected to the controller, may be manually activated by a user, or activated in response to an operation of the tool.

In an embodiment, the frame may be provided with an alignment device at a first end thereof, the alignment device may assist a user in aligning the tool with the surface to be marked.

The alignment device may be operatively connected to the controller, may be manually activated by a user, or may be activated in response to an operation of the tool.

In a second aspect of the invention, there is provided a marker including:
a marking device configured to be actuated by an actuator,
wherein on actuation the marking device deposits a predefined quantity of a material on a work surface to form a mark.

In an embodiment, the marking device includes a canister and a nozzle.

Any suitable canister may be used. The canister may having open and closed ends and configured to retain a material therein, wherein the open end is configured to receive a nozzle thereon.

In some embodiments, the canister may be pressurised. In other embodiments, actuation of the marker causes the canister to become pressurised.

Any suitable nozzle may be used. Generally, the nozzle may be fabricated from a resiliently deformable material, such that the nozzle may be capable of being deformed during actuation of the marker and regains its original shape when the marker returns to the unarmed position.

The marking device may comprise a valve, the valve disposed within the nozzle and/or canister of the marking device. The valve may be located within the nozzle, such that actuation of the marker causes the valve to open, emitting the material through the nozzle.

The valve may be a metering valve configured to deposit a predefined quantity of a material on a work surface.

The valve may be electrically actuated.

The marker may be operatively connected to an actuator, wherein the actuator actuates the marking device to deposit a predefined quantity of a material on a work surface to form a mark.

The marking device may be removed from the cavity separately, or together with, the actuator in order to replace a used marking device.

The material to be deposited on the work surface may vary depending on the surface to be marked and whether the mark is required to be temporary, or permanent. For instance, the material may be chalk, ink, paint, or the like.

In a third aspect of the invention, there is provided a tool including a marking module as hereinbefore described.

The tool including a marking module may be a press or crimp device.

In a fourth aspect, there is provided a use of a marking module for marking a work surface as hereinbefore described.

The use may be marking a work surface to indicate whether pressing has been applied when connecting pipes.

### BRIEF DESCRIPTION OF DRAWINGS

Embodiments of the invention will now be described with reference to the accompanying drawings which are not drawn to scale and which are exemplary only and in which:

FIG. 1 illustrates a right side perspective view of a marking module according to an embodiment of the invention.

FIG. 2 illustrates a left side perspective view of a marking module as illustrated in FIG. 1.

FIG. 3 illustrates a marker for use with a marking module according to an embodiment of the invention.

FIG. 4 illustrates a top view of a tool including a marking module in use according to an embodiment of the invention.

FIG. 5 illustrates a side view a tool including a marking module, according to an embodiment of the invention, a marker shown partially removed from a marking module.

In the drawings, like reference numerals designate similar parts.

### DETAILED DESCRIPTION

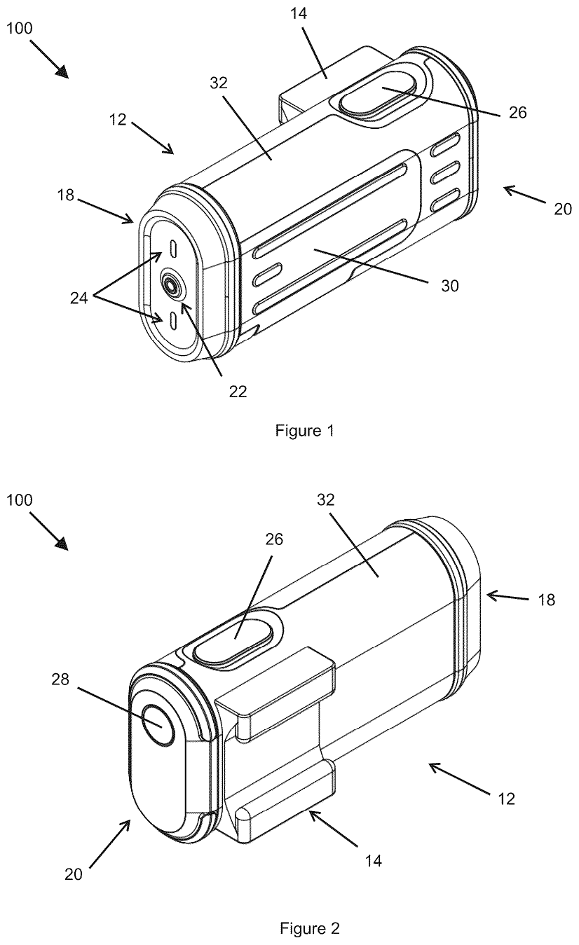

FIGS. 1 and 2 illustrate a marking module (100) for marking a work surface including a mount (not shown) for mounting on a tool; a frame (12) for operatively mounting to a tool, the frame (12) including a bracket (14) movably mounted to the mount, wherein in use the frame (12) is movably mounted to the mount via the bracket (14); a receiver (not shown) configured to receive a marker (50), and an actuator (not shown) operatively connected to the marker (50), the actuator for depositing a predefined quantity of a material on a work surface to form a mark.

The frame (12) may comprise a housing having a first end (18) and an opposed second end (20) and at least one side wall (32) extending therebetween. The at least one side wall (32) forming a cavity therebetween, the cavity configured for receiving a marker (50) and an actuator operatively connected to the marker therein.

The frame (12) may be provided with an opening which allows a user to access the cavity in the frame. A door (30) configured to close the opening may be hingedly connected to the frame (12).

An opening (22) may be located at a first end (20) of the marking module (12) through which the material to be deposited on the work surface is emitted when the actuator is actuated.

An actuator (not shown) may be operatively connected to the marker (50), the actuator for depositing a predefined quantity of a material on a work surface to form a mark. In use, actuation of the marker may cause a valve in the nozzle to open emitting the material.

The frame (12) may be provided with a button (28) operatively connected to a door (30) in the frame, which when pressed, causes the door (30) located in the frame to open such that a user can access or remove the marker (50) from a receiver located within the cavity (not shown) of the frame (12).

An alignment device and/or a lighting device (24) may be located at a first end (20) of the frame (12). The alignment device (24) may be a light, a laser, or the like. The alignment device (24) may assist a user in aligning a tool including the marker module with the surface to be marked and/or may be used to illuminate the surface to be marked such that a user can confirm that the material has been deposited on the surface to be marked.

The frame (12) may include a bracket (14) slidably mounted to the mount enables the frame to move relative to the tool (not shown), such that the distance between the frame and the work surface to be marked can be increased or decreased. In use, the frame (12) may be provided with a button (26), which when pressed allows bracket (14) to slide at least partially along the length of the mount. The frame (12) may be removably mounted to a tool.

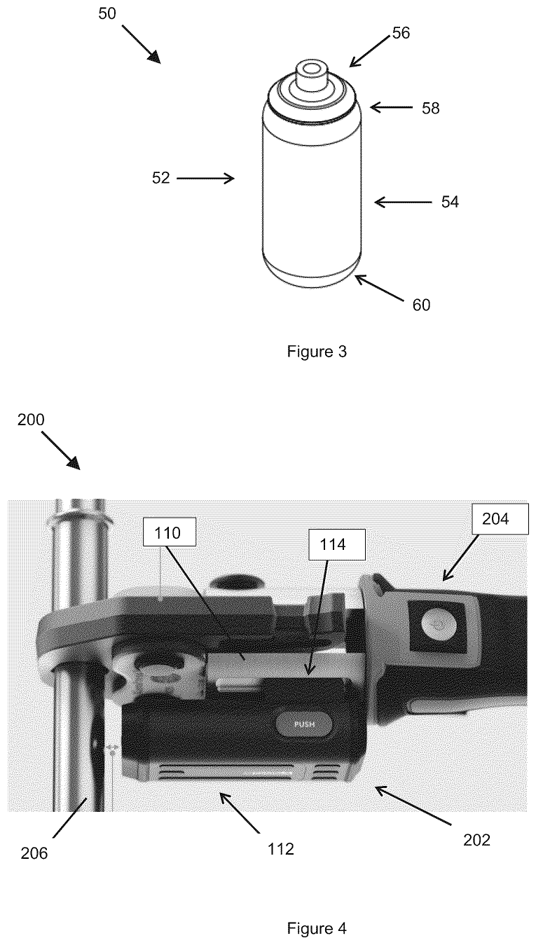

Referring to FIG. 3, a marker (50) for use in a marking module is illustrated. Marker (50) includes a marking device (52) configured to be actuated by an actuator (not shown), wherein on actuation the marking device (52) deposits a predefined quantity of a material on a work surface to form a mark.

Marking device (52) may include a canister (54) and a nozzle (56), wherein on actuation the marking device (52) deposits a predefined quantity of a material through the nozzle (56) on a work surface to form a mark.

The canister (54) may have an open end (58) and a closed end (60), the open end configured to receive a nozzle (56) thereon and the canister (54) configured to retain a material therein.

The marking device (52) may comprise a valve (not shown) disposed within the nozzle and/or canister. The valve may be a metering valve.

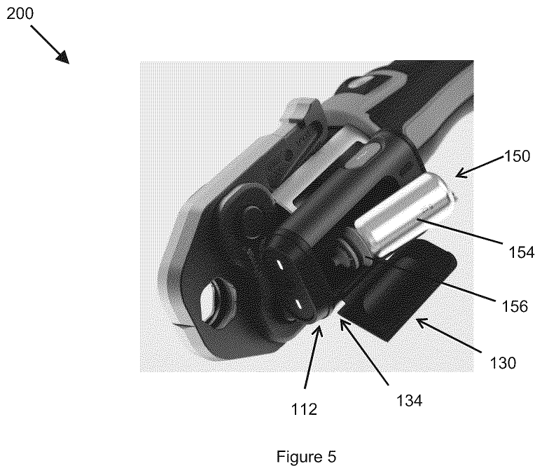

Referring to FIGS. 4 and 5, a tool (200) including a marking module in use is illustrated. Tool (200) comprises a marking module (202) movably mounted on a pipe crimping tool (204). In use, tool (200) is configured to engage with copper pipe (206), wherein actuation of an actuator (not shown) causes the marker (not shown) to deposit a predefined quantity of a material on the copper pipe (206), to form a mark. Frame (112) is movably mounted relative to the mount (110) removably attached to the tool (204) via bracket (114).

In use, a user may open door (130) of the marking module (202) to access a marker (150) received in a receiver (not shown) disposed within the cavity (134) of the marking module to remove and replace a used marking device and/or actuator. The marking device may be removed separately or together with the actuator.

It will of course be realized that while the foregoing has been given by way of illustrative example of this invention, all such and other modifications and variations thereto as would be apparent to persons skilled in the art are deemed to fall within the broad scope and ambit of this invention as is herein set forth.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “including” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

What is claimed is:

1. A marking module for marking a work surface including:
a mount for mounting on a tool;
a frame for operatively mounting to a tool, the frame including a bracket movably mounted to the mount, wherein in use the frame is movably mounted to the mount via the bracket;
a receiver configured to receive a marker, and
an actuator operatively connected to the marker, the actuator for depositing a predefined quantity of a material on a work surface to form a mark.

2. The marking module for marking a work surface according to claim 1, wherein the frame is removably mounted to the tool.

3. The marking module according to claim 1 including:
a controller operatively connected to the actuator and configured to actuate the actuator.

4. The marking module according to claim 2 further comprising a controller operatively connected to actuator and configured to actuate the actuator.

5. The marking module according to claim 1 further comprising:
a button located on the frame and operable by a user, wherein pressing of the button actuates the actuator.

6. The marking module according to claim 5, wherein the button comprises a touch sensor coupled to the actuator.

7. The marking module according to claim 1, wherein the actuator is actuated via a wireless signal.

8. The marking module according to claim 1, wherein the actuator is actuated in response to an operation of the tool.

9. The marking module according to claim 1, wherein the frame is provided with an opening at a first end thereof, the marking device in communication with the opening for emitting the material therethrough.

10. The marking module according to claim 1, further comprising a marker, the marker including a marking device configured to be actuated by the actuator and wherein upon actuation, the marking device deposits a predefined quantity of a material on a work surface to form a mark.

11. The marking module according to claim 10, wherein the marking device includes a canister and a nozzle.

12. The marking module according to claim 1, wherein the frame is provided with a lighting device at a first end thereof.

13. The marking module according to claim 1, wherein the frame is provided with an alignment device at a first end thereof.

14. A marker including:
a marking device configured to be actuated by an actuator,
wherein on actuation the marking device deposits a predefined quantity of a material on a work surface to form a mark.

15. The marker according to claim 14, wherein the marking device includes a canister and a nozzle.

16. The marker according to claim 14, wherein the marking device further includes a metering valve, wherein the metering vale is located in the nozzle.

17. The tool including a marking module according to any claim 1.

18. The tool including a marking module according to claim 1, wherein the tool is a press or crimp device.

19. Use of a marking module according to claim 1, for marking a work surface.
